(19) United States
(12) Patent Application Publication
(10) Pub. No.: US 2006/0106590 A1
(43) Pub. Date: May 18, 2006

(54) Computing services discovery system and method therefor

(75) Inventors: Hui Ming Jason Tseng, Singapore (SG); Emarson Victoria, Singapore (SG); Tau Chen Cham, Singapore (SG)

Correspondence Address: CONLEY ROSE, P.C., P. O. BOX 3267, HOUSTON, TX, 77253-3267, US

(73) Assignee: Agency for Science, Technology and Research, Singapore (SG)

(21) Appl. No.: 10/515,121

(22) PCT Filed: May 16, 2003
(86) PCT No.: PCT/SG03/00112

§ 371 Date: May 4, 2005

(30) Foreign Application Priority Data
May 16, 2002 (SG) SG02/00095
Jun. 3, 2002 (SG) SG02/00110

(51) Int. Cl. G06F 13/10

(52) U.S. Cl. 703/20

(57) ABSTRACT

A computing services discovery system and a method therefor for detecting and discovering properties of deployed computing services in an existing computing system are disclosed. A computing system deployment model introduces layers and clusters for segregating computing system, system and resource components based on their functionality and services provided thereby. Associations between components are registered in profiles to facilitate dependency tracking. The computing system deployment model allows for structured deployment of the computing system onto a host system. However, in an existing computing system, the deployment plan of the deployed computing services is not known. An embodiment of the invention based on the computing system deployment model allows the deployed computing services to be detected and properties describing the components of the services to be extracted. The extracted properties, such as configurations and dependencies of the components, are compiled to provide a re-constructed component profile according to a component profile framework provided by the computing system deployment model. A deployment plan of the deployed computing services is constructed using the information in the re-constructed component profile.

### FIELD OF THE INVENTION

This invention relates to a computing system deployment method. In particular, it relates to a computing services discovery system and a method therefor for detecting and discovering properties of deployed computing services in an existing computing system.

### BACKGROUND

Conventional computing systems, for example enterprise applications, typically possess multi-tier and distributed architectures. Unlike standalone applications in the past, these enterprise applications provide specialized solutions catering to different business needs within organizations or across geographically distant installations. The elaborate structure of these enterprise applications gives rise to a vast quantity of heterogeneous enterprise back-end computing.

Management of the enterprise applications to maintain architectural integrity and performance of the enterprise applications is critical for creating new applications and for providing availability of business services to users.

The aspects of the computing systems typically requiring management includes the deployment and configuration of computing system services, system functionality diagnosis, maintaining the integrity of the component dependencies within a computing system, and monitoring and balancing of computing system component loading for improving computing system performance.

In the course of managing the computing systems, a situation requiring components of an application to be moved between two systems at different locations may arise. Alternatively, new resources may be made available to the system that the enterprise applications reside within. In both these situations, there is a need to reconfigure a previously configured system. In most cases, the deployment of an application or its components requires complicated procedures that requires specialized training in the application being installed as system integrity has to be preserved at all times.

A computing system typically undergoes several configuration changes and a few revisions of its associated components in the course of its life. Once an application is deployed within a system and becomes operational, it will undergo further component replacements, enhancements and expansion in scale. Thus, keeping the dependencies and the integrity of large scale systems becomes problematic as different applications are provided by possibly different vendors. Typically, maintaining the computing systems needs to be performed by an administrator who is deploying the computing systems or applications. In such a situation, the dependencies and inter-connection requirements between computing systems are provided to the administrator in the form of instructional manuals. Further knowledge of the requirements and limitations of each system, application or its components is dependant on the experience and tacit capability of the administrator.

Therefore, it is desirable to have a common framework and method for capturing or specifying all these information in a structured manner, so that the dependency calculations can be automated.

A computing system deployment method addresses the foregoing issues by introducing layers and clusters for segregating computing system, system and resource components based on their functionality and services provided thereby. Associations between components are registered in profiles to facilitate dependency tracking. The computing system deployment model allows for structured deployment of the computing system onto a first host system. The profiles further facilitate migration of the computing system and its associated components onto a second host system without compromising system integrity.

However, for existing infrastructures to benefit from the computing system deployment method, there is a need to examine already deployed computing services in detail to facilitate infrastructure re-architecting, re-alignment processes and optimization.

Existing reverse engineering and software exploration methods and tools are typically domain specific and largely relate to software maintenance and engineering, database reverse engineering and object-oriented design patterns, and recovery for recovering software-coding patterns at source-level. Other such methods and tools are for website and web applications architecture recovery and network topology designing.

These methods and tools do not provide information on how each component as a whole (e.g. web-servers and applications servers) inter-operates with each other, its dependencies and configuration, which are essential information to aid in the understanding of the existing infrastructure as a whole, and planning for new deployments or migration.

Clearly there is a need for a computing services discovery system and a method therefor for detecting and discovering properties of deployed computing services in an existing computing system.

### SUMMARY

A computing services discovery system and a method therefor for detecting and discovering properties of deployed computing services in an existing computing system are disclosed. A computing system deployment model introduces layers and clusters for segregating computing system, system and resource components based on their functionality and services provided thereby. Associations between components are registered in profiles to facilitate dependency tracking. The computing system deployment model allows for structured deployment of the computing system onto a host system. However, in an existing computing system, the deployment plan of the deployed computing services is not known. An embodiment of the invention based on the computing system deployment model allows the deployed computing services to be detected and properties describing the components of the services to be extracted. The extracted properties, such as configurations and dependencies of the components, are compiled to provide a re-constructed component profile according to a component profile framework provided by the computing system deployment model. A deployment plan of the deployed computing services is constructed using the information in the re-constructed component profile.

Therefore, in accordance with a first aspect of the invention, there is disclosed a method for discovering deployed computing services in a computing system, the method comprising the steps of:

providing a discovery pool, the discovery pool comprising at least one component profile, each component profile being associated with a corresponding deployable component, at least one of the component profile being associated with a deployed component;

detecting the presence of a deployed component corresponding to the at least one component profile in the discovery pool; and

extracting information from the deployed component upon detection thereof.

In accordance with a second aspect of the invention, there is disclosed a system for discovering deployed computing services in a computing system, the system comprising:

a discovery pool, the discovery pool comprising at least one component profile, each component profile being associated with a corresponding deployable component, at least one of the component profile being associated with a deployed component;

means for detecting the presence of a deployed component corresponding to the at least one component profile in the discovery pool; and means for extracting information from the deployed component upon detection thereof.

### BRIEF DESCRIPTIONS OF THE DRAWING

Embodiments of the invention are described hereinafter with reference to the following drawing, in which:

FIG. 1 shows a block diagram representing a computing system deployment model;

FIG. 2 shows a block diagram of a layer of the computing system deployment model of FIG. 1 with a plurality of components contained therein being grouped in clusters;

FIG. 3 shows a block diagram of a component profile of each component of FIG. 2;

FIG. 4 shows a process flowchart of discovery steps according to an embodiment of the invention;

FIG. 5 shows an overview of a working environment of the discovery steps of FIG. 4; and

FIG. 6 shown an example of a pseudo-code component detection discovery-script used in the discovery steps of FIG. 4.

### DETAILED DESCRIPTION

A computing services discovery system and a method therefor for detecting and discovering properties of deployed computing services in an existing computing system are provided hereinafter.

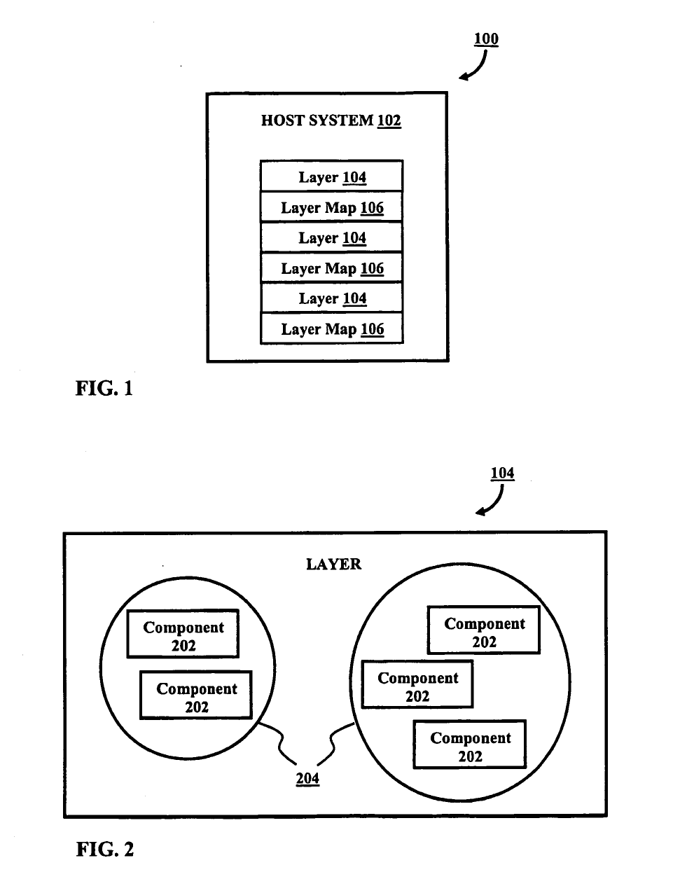

The computing services discovery method and system (hereinafter referred to as “the discovery system”) according to an embodiment of the invention is described with reference to FIGS. 1 to 6. The discovery system is preferably based on a computing system deployment model 100 as shown in FIG. 1.

The computing system deployment model 100 is for planning and realizing a deployment of a computing system (not shown) onto a computer-based host system 102, which typically comprises multiple geographically dispersed sub-systems. The computing system comprises multiple components 202 (as shown in FIG. 2) residing within the host system 102. These components 202 are generally classified as service components, system components and resource components (all not shown in FIG. 1). These components 202 are organized into separate layers 104 within the host system 102. The layers 104 typically include a service layer, system layer and resource layer, which respectively contain service, system and resource components. Each layer 104 has an associated layer map 106. The layer map 106 of each layer 104 indicates the physical locality of a component 202 within the host system 102 and the association of another component 202 therewith.

The service components are for providing one or multiple application-specific, vendor-specific or domain-specific services, which include providing service-related contents such as web-contents and user account data.

The system components are conventionally known as server components and are for providing computing system-based resources and services to other components 202 within the host system 102. Examples of such system components are DNS servers, FTP servers, system libraries, Windows registries and key repositories.

The resource components represent one of a physical hardware that is associated with a computing node or a virtual device representing the physical hardware. Examples of hardware represented by the resource components include network cards, hard disks, routers, firewalls and memory modules.

The components 202 in each layer 104 are grouped into clusters 204 based on the functions thereof as shown in FIG. 2. Each cluster 204 contains at least one component 202. In the service layer, the service components are grouped into service clusters based on the similarity of services provided by each service component. Similarly, in the system layer, the system components are grouped into system clusters based on the function of each system component. Examples of system clusters include an operating system (OS) cluster, a database cluster and a virtual machine cluster. In the resource layer, the resource components are grouped into resource clusters based on the function of the resource component. For example, in the resource layer, there can be a network router cluster, a firewall cluster and a storage cluster.

Each cluster 204 has an associated cluster profile (not shown). The cluster profile contains a description of an associated cluster and a function descriptor describing the function of the components 202 contained therein.

Component Profile

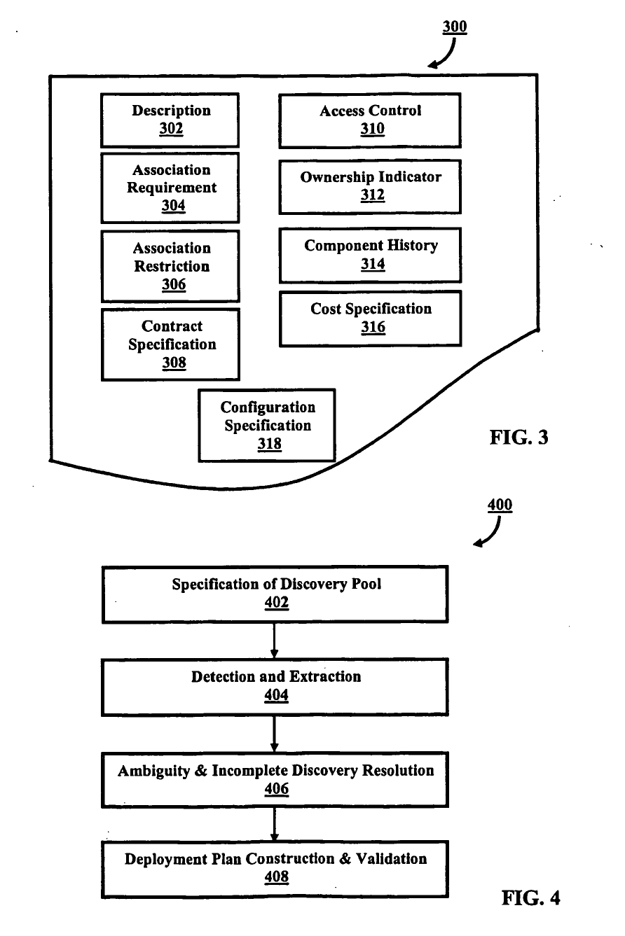

Each component 202 has a corresponding component profile 300 as shown in FIG. 3. The component profile 300 contains management information, which is used for planning the deployment of the component 202. The component profile 300 comprises a description 302 of the associated component 202, at least one association requirement 304, at least one association restriction 306, and at least one contract specification 308, a list of access controls 310, an ownership indicator 312, a component history 314, a list of cost specifications 316 and a configuration specification 318. The association requirement 304 indicates which of the components 202 in the host system 102 are required for associating with the component being described by the component profile 300. For example, in the case of a service component, the component profile 300 is a service profile. Thus, the association requirement 304 indicates system components required for associating with the service component being described by the service profile.

The association restriction 306 indicates which of the components 202 in the host system 102 that are in conflict with and have been prohibited from accessing the component being described by the component profile 300. The association restriction 306 further provides information on potential and known conflicts. The information on the conflicts allows the conflicts to be properly managed or alleviated during the deployment of the computing system.

The contract specification 308 states the information to be provided by a corresponding component 202 for accessing the component 202 described by the component profile 300. An application of the contract specification is illustrated using a hypertext transfer protocol (HTTP) server (not shown) as follows. The system component of the HTTP server, for example an Apache HTTP server, requires a valid alias and a root directory location to be specified for access thereto. The valid alias and root directory location requirements are stated in the contract specification 308 of the system profile describing the system component of the Apache HTTP server. Therefore, a service component of an Enterprise server, for example, requiring access to the system component of the Apache HTTP server has to be provided with information required by the contract specification 308 thereof. The service component of the Enterprise server then provides the Apache HTTP server with the required valid alias and root directory location to the system component of the Apache HTTP server for access of the same thereby in accordance to the association requirements 304 of the service profile describing the service component.

The list of access controls 310 specifies the ability of a component 202 contained in another cluster 204, preferably from the same layer 104, to access the component 202 being described by the component profile 300 and vice-versa. The access controls 310 are conventionally provided by the vendors of the components 202 in the host system 102 to avoid association of components 202 supplied by one vendor from accessing or being accessed by components 202 supplied by another vendor. Further, the access controls 310 can be utilized for marketing, political, security or operational reasons.

The ownership history 312 indicates one or multiple owners of the component 202 described by the component profile 300 and the relative priority that each owner has over the component 202 based on the configuration of the deployment. The owner is one or more of any combination of a system including the host system 102, a cluster including the service, system and resource clusters, and a component 202 in the host system 102.

The component history 314 tracks the current and past configuration the component described by the component profile 300 is deployed upon. The component history 314 further reflects the dependency of other components 202 in the host system 102 on the component. The component history 314 is further used for restoring and archiving deployed computing systems. This enables any corruption to the computing system or the components therein to be rectified by enabling redeployment or restoration of the computing system to its most recent pre-corrupted state.

The list of cost specifications 316 specifies the corresponding cost of using of the component 202 being described by the component profile 300. The cost of using a component includes virtual memory usage (for example a random access memory or RAM), physical storage usage (for example a hard disk drive), the physical storage expansion requirements with respect to time and the like system resource requirements. The cost specifications 316 allows an administrator of a computing system to decide upon the viability of installing a component or a cluster of components while considering the current and future impact on system resource requirements if the component is installed.

The component configuration specification 318 specifies multiple configuration parameters for deploying the component. Each parameter is specified as a key-value pair, wherein the key refers to the parameter name, such as “application-name” and the value refers to as specific value corresponding to the parameter name, in this case, the specific application name, such as “oracle”. Another example of a key-pair is “server-port=80”. Other parameters include run-time information relating to how each component 202 is deployable and alterable parameters that affect the run-time behavior of the component 202. The run-time information includes installation paths, network ports and addresses, location of application-specific configuration files and logs, and the like component configuration details. The run-time information is one of application-specific, domain-specific and vendor-specific and ensures substantial accuracy in planning for the deployment of the computing system or the realization of the computing system infrastructure.

Discovery Steps

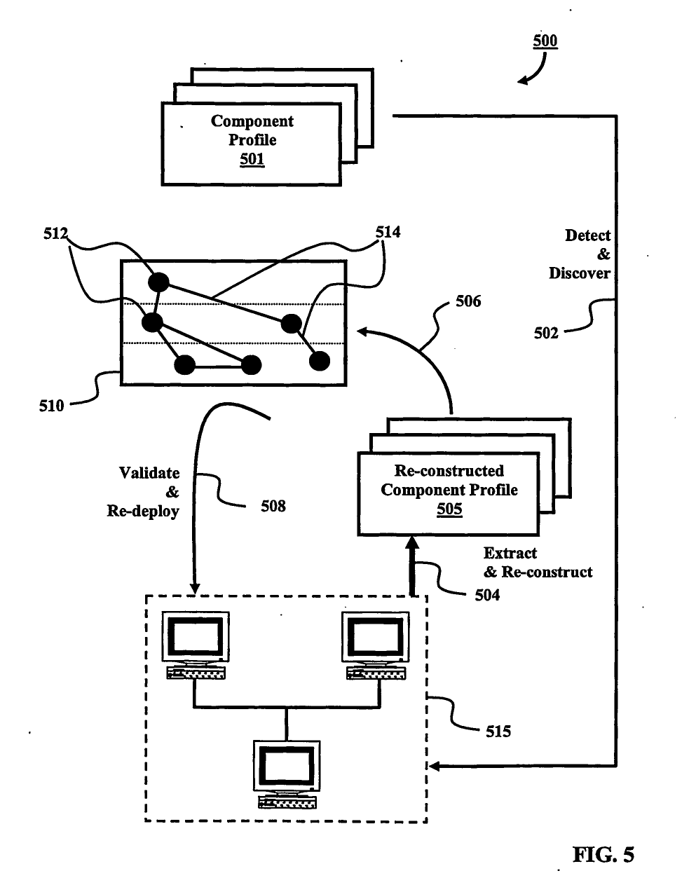

Using the framework of the component profile 300 described in the foregoing with reference to FIG. 3, computing services deployed in an existing computing system can be discovered by performing discovery steps 400 as shown in FIG. 4.

The operational principle behind the discovery steps 400 is based on the fact that most, if not all, component profiles of deployed components in the existing computing system have a default or recommended configuration. Further, deployment of these components tends not to deviate too much from the recommended configuration and certain parameters used in the recommended configuration are also used or customized in the actual deployment. However, it is unlikely that one vendor supplies all the deployed components. As such, information in the component profiles supplied by one vendor typically differs from information in the component profiles supplied by another vendor.

The discovery steps 400 seek to detect the presence of the deployed components and discover the properties (i.e. configuration and dependencies information) of the detected components and re-organize these discoveries into the framework of the component profile 300 for aiding the construction of a reusable deployment plan using the computing system deployment model 100 described in the foregoing.

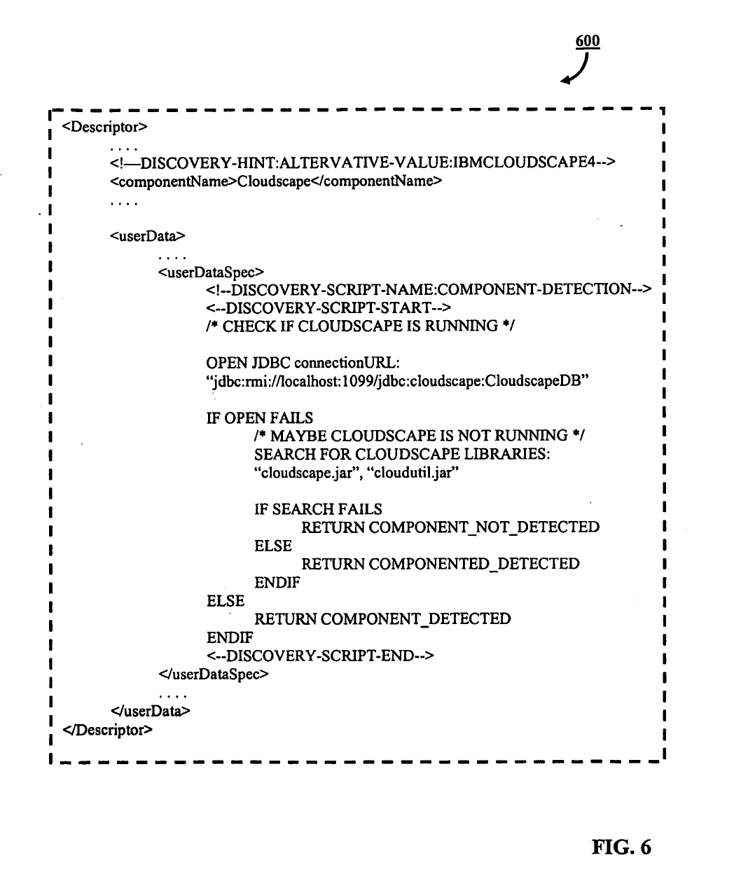

The operation of the discovery steps 400 is illustrated with reference to FIG. 5, which shows an overview of a working environment 500 for the discovery steps 400. The working environment 500 comprises a pool of component profiles 501, which are typically supplied by different vendors, a pool of re-constructed component profiles 505, a deployment plan 510 and an existing computing system 515. The objective of the discovery steps 400 is to discover and extract information to re-constructed the re-constructed component profiles 505, which are in the framework of component profile 300. Initially, the content of the re-constructed component profiles 505 is not known. Thus, the deployment plan 510, which comprises components 512 and dependencies 514 linking the components 512, are also not known. The components 512 typically comprise service, system and resource components, while the dependencies 514 are stipulated in the component profiles corresponding to each component 512. The content of the re-constructed component profiles 505 is embedded in the deployed components within the existing computing system 515 as stipulated in the component profile 501 supplied by different vendors. The deployed components need to be detected and the properties therein need to be discovered via a detection and discovery process 502. Once discovered, the configurations and dependencies information of the detected components are extracted 504 to re-construct the re-constructed component profiles 505. Using the re-constructed component profiles 505, the deployment plan 510 of the deployed computer services is created 506. Thereafter, the constructed deployment plan 510 can be fine-tuned, validated, extended with new deployments and redeployed 508 to provide an improved and easy to manage computing system.

The discovery steps 400 comprise a specification of discovery pool step 402, a detection and extraction step 404, an ambiguity and incomplete discovery resolution step 406 and a deployment plan construction and validation step 408 as shown in FIG. 4.

Specifying Discovery Pool

The specification of discovery pool step 402 is concerned with specifying or identifying a pool of component profiles for detecting the associated deployed components. Typically, these component profiles are provided by the vendors of the deployed components and contain default and/or recommended deployment parameters. The step 402 preferably involves performing one or more of the following tasks:
(a) Selecting one or more component profiles from a component profile library in the computing system.
(b) Selecting one or more component profile libraries from which component profiles are identified for including into the discovery pool.
(c) Creating new component profiles and discovery proxies for use in discovering the profiles of the deployed components, if component profiles of the deployed components are not readily available.
(d) Selecting one or more component profiles from any form of component profile repositories, for example, web-site repositories.

Each discovery proxy specifies either discovery-scripts for self-constructing (or self-discovering) the profile of a corresponding deployed component or a link to another component profile from which the properties therein can be inherited when re-constructing the profile of the corresponding deployed component. The information discovered by the discovery-scripts associated with the discovery proxy is compiled to provide a component profile, wherein the management information of the deployed component is arranged according to the framework of the component profile 300.

The discovery-scripts are platform-dependent or platform-independent scripts, which are executed during the detection and extraction step 404 as described hereinafter. Existing software reverse-engineering techniques such as source-code-level and binary-level analysis can be incorporated into the discovery scripts, depending on the granularity of extraction and level of understanding of the deployed components needed and difficulties in discovering the information. The discovery-scripts can also serve as additional discovery hints to enhance the detection and extraction process. Thus, component profiles can be tailored not just for planning and deployment but also for the discovery thereof. That is, the component profiles can be used as a means for specifying explicit instructions to drive and guide the detection and extraction process. Examples of the discovery-scripts include:
Component Detection discovery-script—used for detecting the presence of the deployed component;
Configuration Extraction discovery-script—used for extracting configuration information of the deployed component upon detection thereof;
Contract Extraction discovery-script—used for extracting dependencies and contract information of the deployed component upon detection thereof;
Self-construct discovery-script—used in self-constructing discovery proxies and when executed performs component detection, property extraction and completely re-constructs the component profile of the deployed component in accordance with the framework of the component profile 300; and
Service discovery-script—used for discovering complete services that may be composed of multiple deployed components, thus, performing multiple component discoveries.

In order to enhance the detection of component dependencies and conflicts, components that are specified in the association requirement and association restriction properties of each specified component profile may be automatically included into the discovery pool. However, the dependencies and mandatory contract specifications of the components automatically included into the discovery pool are preferably validated in this step 402 according to the contract specification 308 as defined in the component profile of each deployed component. Therefore, components that meet the association requirement but do not meet the contract specification are not included into the discovery pool.

Detecting and Extracting

Once the pool of component profiles is specified, the detection and extraction step 404 is initiated to search for the deployed components corresponding to the specified component profiles in the discovery pool and extract properties therefrom upon detecting the deployed components. The step 404 comprises three sub-steps:
(i) detecting the presence of deployed components;
(ii) extracting detected component configuration; and
(iii) determining detected component dependencies.

In the sub-step (i), a component corresponding to a specified component profiles in the discovery pool is deemed successfully detected if one or a combination of the following weighted parameters are detected in the file-system, system resources (such as network ports), system registries or other operating system dependent information source.

Base Directory Detection. A BasePath pathname attribute in the configuration property, which specifies the default base pathname location for the deployed component, matches fully or partially against pathnames that exist in the actual file-system. For partial matching, only the last element of the pathname is matched. The matching process is non-case sensitive and involves discarding any leading or ending non-alphabetical and white-space characters.

Configuration File Detection. A filename specified by a ConfigFile attribute in the configuration property matches fully or partially with one or more filenames that exist in the detected base directory or sub-directories thereof.

Error Log File Detection. A filename specified by an ErrorLog attribute in the configuration property matches fully or partially with one or more filenames that exist in the detected base directory or sub-directories thereof.

Log File Detection. A filename specified by a Log attribute in the configuration property matches fully or partially with one or more filenames that exist in the detected base directory or sub-directories thereof.

A Content Detection. One or more filenames or pathnames specified in the content property (not shown in FIG. 3) matches with one or more filenames that exist in the detected base directory or sub-directories thereof.

Component Name Detection. A Component Name attribute in the descriptor property matches a filename or directory name fully or partially in the existing file-system or a key in a system registry.

Vendor name Detection. A Component Vendor Name attribute in the descriptor property matches a filename or directory name fully or partially in the existing file-system or a key in a system registry.

Discovery-script Component Detection Test. For discovery proxies or component profiles with discovery-scripts, executing the component detection discovery-scripts returns a COMPONENT_DETECTED or COMPONENT_NOT_DETECTED result.

Using a simple conditional probability, which measures the likelihood that a component is present, the final score of a component, after the performance of the sub-step (i), is given by:

$${\prod }_{i = 1}^{n} {p}_{i} \cdot {w}_{i}$$

where p represents the likelihood that a parameter is present, the value of p is between 0 and 1, with 1 indicating that the parameter is very likely to be present, w represents a weight associating with the parameter, the value of w is between 0 and 1, with 1 indicating that the parameter is very important, and n represents the number of parameters associated with one component.

Further, the foregoing detection conditions can be used to test for heuristics by using the association requirement and association restriction properties specified in the component profiles. These heuristics includes (a) Absence of Conflicts—no conflicting components detected and (b) Presence of Dependencies—detected presence of some or all dependant deployed components.

The outcome of the sub-step (i) is the successful detection of deployed components having corresponding component profiles as specified in the discovery pool. Further, any successfully detected conditional values or attributes are also updated into the appropriate properties and attributes of the corresponding component profiles. These updated component profiles are referred to as re-constructed component profiles. Information in each re-constructed component profile is arranged in a systematic and consistent manner in accordance with the component profile 300 framework described in the foregoing with reference to FIG. 3.

If the discovered attributes of the detected component fail to match with the attributes that are specified in the corresponding component profile, the detected component is tagged with an Identity-Incomplete status. If two or more detected components are found to match with one component profile specified in the discovery pool, each of these detected components is tagged with an Identity-Ambiguous status.

In the sub-step (ii), information relating to the configurations of the detected components are extracted and updated in the configuration property of the corresponding re-constructed component profiles. Attributes that are previously updated in the sub-step (i) are ignored. Incomplete and un-customized or default attributes are information that need to be extracted from the detected components.

For discovery proxies or component profiles with discovery-scripts, the extraction process is performed by executing the configuration extraction discovery-script therein. Otherwise, if configuration files are detected in the sub-step (i), partial matching of configuration keys is performed to deduce and extract the corresponding key values from the configuration files. This is achieved by performing string matching against the detected configuration files. This matching is also extended to the system registry, if one exists. If the component profile specifies only one default configuration set, which comprises multiple configuration key-value pairs of a component, in this case all the configuration key-value pairs, but multiple configuration sets are extracted from the detected component, the detected component is tagged with a Configuration-Ambiguous status. Thus, several possible configuration sets are generated for the user to choose from However, if the extraction process fails to extract configuration keys specified in the component profile, the detected component is tagged with a Configuration-Incomplete status.

The outcome of the sub-step (ii) is the updated configuration information in the configuration property of the re-constructed component profiles of the detected deployed components. Further, each detected component is tagged with an appropriate status.

In the sub-step (iii), one or more detected components having dependency relationships detected in the sub-step (i) are verified to comply with mandatory dependency relationships specified in the requirement property of the corresponding component profiles. To determine if a dependency relationship of the one or more detected components is valid, contract information is extracted from the detected components and compared against contract information specified in the corresponding component profiles. If contract information cannot be extracted, the dependency relationship is deemed invalid.

For discovery proxies or component profiles with discovery-scripts, the contract extraction discovery-script is used for extracting contract information from the detected components. If there are no discovery-scripts and if configuration files are detected for the components having the same dependency relationship, partial matching of default and mandatory contract keys contained in the configuration files of the detected components is performed to deduce and extract common contract values that describe the dependency relationship. If a system registry exists, the matching process is also extended thereto. If the required dependency contract key and value cannot be determined, the dependency relationship is deemed invalid.

If one or more mandatory dependency relationships are not uniquely matched or validated, each of the corresponding detected components is tagged with a Dependency-Ambiguous status. If a complete match or one mandatory dependency relationship is not successfully verified, each of the corresponding detected components is tagged with a Dependency-Incomplete status.

The outcome of the sub-step (iii) is the confirmation of the dependency relationships between the detected components as specified in the corresponding component profiles.

Ambiguity and Incomplete Discovery Resolution

The ambiguous or incomplete status of each of the detected components tagged in the steps 402 and 404 are further fine-tuned in the step 406.

The step 406 requires user-assistance and preferably involves computer-assisted tools in the ambiguity and incomplete discovery resolution. For the ambiguous discoveries, namely, the identity, configuration and dependency ambiguities, the user is required to select one of the detected alternatives for each of the ambiguities. For the incomplete discoveries, namely, the identity, configuration and dependency incompletes, the user is required to provide the incomplete parameters and attributes in the corresponding component profiles.

Alternatively, this step 406 can be skipped. The ambiguity and incomplete discoveries can be further refined in the step 408 where deployment plan construction and validation processes are performed.

Deployment Plan Construction and Validation

In the step 408, a deployment plan is constructed from the re-constructed component profiles of the corresponding detected deployed components provided by the previous steps 402, 404 and 406. Further, the constructed deployment plan can be validated in accordance with the computing system deployment model 100 described in the foregoing with reference to FIG. 1.

The deployment plan is preferably graphically presented as nodes (each node represents a component) and dependency lines linking the nodes for indicating dependency relationships therebetween, like the exemplary deployment plan 510 shown in FIG. 5.

To refine and validate the deployment plan, comprehensive editing facilities are provided. These editing facilities enable a user to fine-tune the deployment plan and the re-constructed component profiles. In addition, importing and incorporating additional component profiles for including into the deployment plan is also possible.

The re-constructed component profiles can be exported for further fine-tuning by including specific discovery-scripts to enhance detection and extraction accuracy. Thus, the enhanced re-constructed component profiles can be put through the discovery steps 400 again to provide improved component profiles and deployment plan.

The step 408 also addresses over-detection and under-detection issues. Over-detection of deployed components, which is partially addressed in the earlier steps where such components are tagged with ambiguous and/or incomplete statuses, arises from incorrect detection conditions or incorrect assignment of parameter weights. Thus, in the step 408, components that appear in the deployment plan but are not actually deployed in the computing system are removed or deleted from the deployment plan. The over-detection issue can be address by making the default detection conditions and weights dynamically adjustable or by having an adaptive or self-learning detection process. Alternatively, specific discovery-scripts are needed to accurately detect specific components.

Under-detection is typically detection misses that occur due to the following factors:
Deployed components having corresponding component profiles that are not specified in the discovery pool;
Deployed components having corresponding component profile that are specified in the discovery pool but the component profiles fail to provide sufficient hints for detecting the deployed components or the deployed components are heavily customized since the deployment thereof rendering the deployed components unrecognizable (i.e. cannot be generically detected); and
Deployed components do not have corresponding component profiles.

The first factor can be easily resolved by including the component profiles into the specified discovery pool. The second factor can be addressed by fine-tuning or relaxing the detection conditions and weights. Alternatively, discovery-scripts can be used to accurately detect the deployed components. The third factor can be addressed by creating a component profile for each of the detected components. Discovery proxy can be provided to automatically self-construct a component profile from the discoveries made by the execution of the discovery-scripts therein. Alternatively, a component profile can be recreated in a conventional manual way by describing the corresponding detected component and embedding hints therein for use during the detection and extraction process.

An Example

To further clarify the embodiment of the invention, an example is provided hereinafter. In the example, a Java Petstore service is independently deployed in a computing system. The Java Petstore service comprises the following components: Petstore application (i.e. J2EE enterprise archives or EAR), J2EE SDK, Apache Tomcat servlet container and Cloudscape database. By applying the discovery system described in the foregoing with reference to FIGS. 1 to 5, the Java Petstore service can be discovered and a deployment plan for the deployed Java Petstore service can be constructed for reference, modifications, and redeployment.

Specifying Discovery Pool

The four component profiles of the Java Petstore service are selected from the component profile library in the computing system for including into the discovery pool. If the four component profiles are not known, all component profiles from all the component profile libraries in the computing system are included into the discovery pool. The detection and extraction process then detects the deployed components and re-construct the corresponding component profiles.

For example, to discover the Cloudscape database component, a pseudo-code component detection discovery-script 600 as shown in FIG. 6 is used. The discovery-script 600 is inserted into the userData section of the description portion of the component profile. In addition, discovery hints can be provided to inform the discovery process that the Cloudscape database component has an alternative name: “IBMCLOUDSCAPE4”.

Detecting and Extracting

Once the component profiles are specified, the detection and extraction process is initiated to search for the deployed components corresponding to the specified component profiles.

(i) Detecting the Presence of Deployed Components.

Possible outcomes of the detection process for the four specified component profiles are:

Petstore EAR Component Profile: The BasePath pathname attribute in the component profile specifies: “J2EE-BluePrint\Petstore\”. The local file-system is searched, looking for a directory name that matches “J2EE=BluePrint\Petstore”. However, the directory name cannot be found. Thus, only the last component of the BasePath pathname is used for subsequent search. The “Petstore” directory is subsequently found in the local file-system. Other detection parameters, such as error log file, can also be performed and the combined results are weighted and normalized. The final score is used to determine if a successful match is obtained. In this example, the Petstore component is matched and successfully detected.

J2EE SDK Component Profile: Similar detection is performed for this component profile. The BasePath condition matches the directory name: “j2sdkee1.3.1” in the local file-system. In addition, a configuration file “resource.properties” is found.

Apache Tomcat Component Profile: Similar detection is performed for this component profile. The BasePath condition matches the directory name: “conf” in the local file-system. In addition, a configuration file “server.xml” is found.

Cloudscape Component Profile: Detection is performed by using a component detection discovery-script. Other detection parameters specified in the configuration specification can also be used, but preferably a high weight is assigned to the results discovered by the discovery-script because the discovery-script is written to specifically discover the parameters, thus more accurate. If Component Name detection is used (i.e. discovery hint), detection of the alternative component names may be found. In the example, assuming the Cloudscape database is operational, executing the discovery-script returns a COMPONENT_DETECTED result and a configuration file “service.properties” for the default database is found.

(ii) Extracting Detected Component Configuration.

Possible outcomes of the extraction process for the four specified component profiles are:

Petstore EAR Component Profile: No configuration file is detected in the previous step. Further, the component profile does not contain discovery-script for configuration extraction. Thus, the Petstore component is tagged with Configuration-Incomplete status.

J2EE SDK Component Profile: Information relating to default and mandatory configuration attributes as defined in the re-constructed J2EE SDK component profile is extracted from the configuration file “resource.properties”.

Apache Tomcat Component Profile: Information relating to default and mandatory configuration attributes as defined in the re-constructed Apache Tomcat component profile is extracted from the configuration file “server.xml”.

Cloudscape Component Profile: Information relating to default and mandatory configuration attributes as defined in the re-constructed Cloudscape component profile is extracted from the configuration file “service.properties”.

(iii) Determining Detected Component Dependencies.

Petstore EAR Component Profile: No configuration file is detected in the previous step. Further, the component profile does not contain discovery-script for dependency and/or contract information extraction. Thus, the Petstore component is tagged with Dependency-Incomplete status.

J2EE SDK Component Profile: The re-constructed J2EE SDK component profile specifies a mandatory dependency on the Apache Tomcat component and a JDBC database component with default and mandatory contract keys. Since the Apache Tomcat and Cloudscape components are detected, these are matched as possible dependencies. For each of these dependencies, the detected configuration file “resource.properties” is processed together with the configuration files of the Apache Tomcat and Cloudscape components. Common keys matched between two configuration files that minimally satisfy the mandatory contract keys of the J2EE SDK component indicates a valid dependency relationship. In the example, it is assumed that all mandatory keys of the J2EE SDK component are matched with that of the Apache Tomcat component but none is found for the Cloudscape component. Thus, the J2EE SDK component is tagged with a Dependency-Incomplete status.

Apache Tomcat Component Profile: The re-constructed Apache Tomcat component profile specifies no mandatory dependencies.

Cloudscape Component Profile: The re-constructed Cloudscape component profile specifies no mandatory dependencies.

Ambiguity and Incomplete Discovery Resolution

From the previous steps, the Petstore component is tagged with Configuration-Incomplete and Dependency-Incomplete statuses, while the J2EE SDK component is tagged with a Dependency-Incomplete status. In this step, user assistance is required to completely describe the configurations and dependencies of the two detected components.

Construction and Validation

A draft deployment plan can be constructed based on the detected components and configurations and dependencies in the corresponding re-constructed component profiles. The draft deployment plan is further analyzed and validated in accordance with the computing system deployment model 100 shown in FIG. 1. User can choose to fine-tune the draft deployment plan to arrive at a final deployment. Alternatively, the re-constructed component profiles can be further enhance by incorporating discovery-scripts and repeat the discovery steps 400 to provide an improved draft deployment plan.

In the foregoing manner, computing services discovery method and system for detecting and discovering deployed computing services in an computing system is described according to an embodiment of the invention for addressing one or more of the foregoing disadvantages of conventional methods and tools. It will be apparent to one skilled in the art in view of this disclosure that numerous changes, modifications and combinations can be made without departing from the scope and spirit of the invention.

1. A method for discovering deployed computing services in a computing system, the method comprising the steps of:
providing a discovery pool, the discovery pool comprising at least one component profile, each component profile being associated with a corresponding deployable component, at least one of the component profile being associated with a corresponding deployed component of a computing service;
detecting the presence of a deployed component corresponding to the at least one component profile in the discovery pool; and
extracting information from the deployed component upon detection thereof.

2. The method as in claim 1, wherein the step of providing the discovery pool comprises the step of specifying at least one component profile contained in one or a combination of a component profile library and a component profile repository in a computing system.

3. The method as in claim 1, wherein the step of providing the discovery pool comprises the step of creating at least one component profile for representing at least one corresponding component deployed in a computing system.

4. The method as in claim 1, wherein the step of providing the discovery pool comprises the step of providing at least one self-constructing discovery proxy, the at least one self-constructing discovery proxy comprising at least one discovery-script which when executed performs at least one of component detection, attribute extraction and reconstruction of a component profile of the detected deployed component.

5. The method as in claim 1, wherein the step of detecting the presence of the deployed component comprises the step of executing a component detection discovery-script, the component detection discovery-script being able to search for an attribute of the deployed component.

6. The method as in claim 5, wherein the step of detecting the presence of the deployed component further comprising the step of tagging the detected deployed component with one of an Identity-Ambiguous status when the component profile associated therewith is associated with at least two detected deployed component and an Identity-Incomplete status when information relating to the detected deployed component differs from information specified in the at least one component profile corresponding to the detected deployed component.

7. The method as in claim 1, wherein the step of detecting the presence of the deployed component comprises the step of declaring a successful detection of the deployed component when information in the component profile of the deployed component is found, the information in the component profile comprising at least one of:
a BasePath a pathname of the deployed component;
a configuration file of the deployed component;
an ErrorLog filename of the deployed component;
a Log filename of the deployed component;
a Content filename of the deployed component;
a Component Name filename of the deployed component; and
a Component Vendor Name filename of the deployed component.

8. The method as in claim 7, wherein the step of detecting the presence of the deployed component further comprising the step of tagging the detected deployed component with an Identity-Ambiguous status when the component profile associated therewith is associated with at least two detected deployed component.

9. The method as in claim 8, wherein the step of detecting the presence of the deployed component further comprising the step of tagging the detected deployed component with an Identity-Incomplete status when information relating to the detected deployed component differs from the information specified in the at least one component profile corresponding to the detected deployed component.

10. The method as in claim 7, wherein the step of detecting the presence of the deployed component further comprising the step of tagging the detected deployed component with an Identity-Incomplete status when information relating to the detected deployed component differs from the information specified in the at least one component profile corresponding to the detected deployed component.

11. The method as in claim 1, wherein the step of extracting information comprises the step of extracting information relating to the configuration and contract specifications of the detected deployed component contained in a configuration file thereof.

12. The method as in claim 11, wherein the step of extracting information further comprising the step of compiling the extracted configuration and contract information to provide a re-constructed component profile, the re-constructed component profile comprising a plurality of properties, each property being descriptive of an attribute of the associated detected deployed component.

13. The method as in claim 11, wherein the step of extracting information further comprising the step of tagging the detected deployed component with a Configuration-Ambiguous status when upon comparing the configuration information of the detected deployed component with the configuration information specified in the component profile of the detected deployed component, at least one uncommon information is found in the configuration information of the detected deployed component.

14. The method as in claim 11, wherein the step of extracting information further comprising the step of tagging the detected deployed component with a Configuration-Incomplete status when the configuration information specified in the component profile of the detected deployed component is not found.

15. The method as in claim 11, wherein the step of extracting information further comprising the step of tagging the detected deployed component with a Dependency-Ambiguous status when a mandatory dependency relationship specified in the component profile of the detected deployed component does not uniquely match with a dependency relationship found in the detected deployed component.

16. The method as in claim 11, wherein the step of extracting information further comprising the step of tagging the detected deployed component with a Dependency-Incomplete status when a mandatory dependency relationship specified in the component profile of the detected deployed component is not found in the detected deployed component.

17. The method as in claim 1, further comprising the step of constructing a deployment plan of the deployed computing services in a computing system based on the detected component and information extracted therefrom.

18. The method as in claim 12, further comprising the step of constructing a deployment plan of the deployed computing services in a computing system based on the information in contained in the re-constructed component profile.

19. A system for discovering deployed computing services in a computing system, the system comprising:
a discovery pool, the discovery pool comprising at least one component profile, each component profile being associated with a corresponding deployable component, at least one of the component profile being associated with a deployed component;
means for detecting the presence of a deployed component corresponding to the at least one component profile in the discovery pool; and
means for extracting information from the deployed component upon detection thereof.

20. The system as in claim 19, wherein the at least one component profile is provided within one or a combination of a component profile library and a component profile repository in a computing system.

21. The system as in claim 19, wherein the at least one component profile is a self-constructing discovery proxy, the self-constructing discovery proxy comprising at least one discovery-script which when executed performs at least one of component detection, attribute extraction and reconstruction of a component profile of the detected deployed component.

22. The system as in claim 19, wherein the means for detecting the presence of the deployed component comprises the means for executing a component detection discovery-script, the component detection discovery-script being able to search for an attribute of the deployed component.

23. The system as in claim 22, wherein the means for detecting the presence of the deployed component further comprising means for tagging the detected deployed component with one of an Identity-Ambiguous status when the component profile associated therewith is associated with at least two detected deployed component and an Identity-Incomplete status when information relating to the detected deployed component differs from information specified in the at least one component profile corresponding to the detected deployed component.

24. The system as in claim 19, wherein the means for detecting the presence of the deployed component comprises means for declaring a successful detection of the deployed component when information in the component profile of the deployed component is found, the information in the component profile comprising at least one of:
a BasePath a pathname of the deployed component;
a configuration file of the deployed component;
an ErrorLog filename of the deployed component;
a Log filename of the deployed component;
a Content filename of the deployed component;
a Component Name filename of the deployed component; and
a Component Vendor Name filename of the deployed component.

25. The system as in claim 24, wherein the means for detecting the presence of the deployed component further comprising means for tagging the detected deployed component with an Identity-Ambiguous status when the component profile associated therewith is associated with at least two detected deployed component.

26. The system as in claim 25, wherein the means for detecting the presence of the deployed component further comprising means for tagging the detected deployed component with an Identity-Incomplete status when information relating to the detected deployed component differs from the information specified in the at least one component profile corresponding to the detected deployed component.

27. The system as in claim 24, wherein the means for detecting the presence of the deployed component further comprising means for tagging the detected deployed component with an Identity-Incomplete status when information relating to the detected deployed component differs from the information specified in the at least one component profile corresponding to the detected deployed component.

28. The system as in claim 19, wherein the means for extracting information comprises means for extracting information relating to the configuration and contract specifications of the detected deployed component contained in a configuration file thereof.

29. The system as in claim 28, wherein the means for extracting information further comprising means for compiling the extracted configuration and contract information to provide a re-constructed component profile, the re-constructed component profile comprising a plurality of properties, each property being descriptive of an attribute of the associated detected deployed component.

30. The system as in claim 28, wherein the means for extracting information further comprising means for tagging the detected deployed component with a Configuration-Ambiguous status when upon comparing the configuration information of the detected deployed component with the configuration information specified in the component profile of the detected deployed component, at least one uncommon information is found in the configuration information of the detected deployed component.

31. The system as in claim 28, wherein the means for extracting information further comprising means for tagging the detected deployed component with a Configuration-Incomplete status when the configuration information specified in the component profile of the detected deployed component is not found.

32. The system as in claim 28, wherein the means for extracting information further comprising means for tagging the detected deployed component with a Dependency-Ambiguous status when a mandatory dependency relationship specified in the component profile of the detected deployed component does not uniquely match with a dependency relationship found in the detected deployed component.

33. The system as in claim 28, wherein the means for extracting information further comprising means for tagging the detected deployed component with a Dependency-Incomplete status when a mandatory dependency relationship specified in the component profile of the detected deployed component is not found in the detected deployed component.

34. The system as in claim 19, further comprising means for constructing a deployment plan of the deployed computing services in a computing system based on the detected component and information extracted therefrom.

35. The system as in claim 29, further comprising means for constructing a deployment plan of the deployed computing services in a computing system based on the information in contained in the reconstructed component profile.
